(19) United States
(12) Patent Application Publication
(10) Pub. No.: US 2016/0248809 A1
(43) Pub. Date: Aug. 25, 2016

(54) METHODS AND APPARATUS TO PROCESS DATA BASED ON AUTOMATICALLY DETECTING A SECURITY ENVIRONMENT

(71) Applicant: Intel Corporation, Santa Clara, CA (US)

(72) Inventors: NED M. SMITH, Beaverton, OR (US); ABHILASHA BHARGAV-SPANTZEL, Santa Clara, CA (US); ODED BAR-EL, Zikhron Ya'akov (IL)

(21) Appl. No.: 14/628,016

(22) Filed: Feb. 20, 2015

(51) Int. Cl. H04L 29/06

(52) U.S. Cl. CPC H04L 63/20; H04L 63/06; H04L 63/0435

(57) ABSTRACT

Methods and apparatus to process data based on automatically detecting a security environment are disclosed. An example apparatus includes an input device, an environment identifier, a security level selector, and a secure data processor. The input device captures information indicating a physical environment in which the computing device is located. The environment identifier identifies a security environment based on the captured information and a security policy, the security policy defining the security environment and security levels. The security level selector selects, based on the security environment, one of the security levels to be authorized at the computing device within the security environment. The secure data processor processes data based on the selected security level.

### FIELD OF THE DISCLOSURE

This disclosure relates generally to data security, and, more particularly, to methods and apparatus to process data based on automatically detecting a security environment.

### BACKGROUND

Ensuring user compliance with data security policies is an increasingly difficult challenge to organizations. This challenge has increased due to the rise in bring-your-own-device programs, in which employees (or other users) of the device are permitted to use the devices that they own to perform tasks that require access to secure data. While users desire that any security policies that are applied to their devices be unobtrusive, known security policies must be obtrusive to obtain compliance with such security policies.

### BRIEF DESCRIPTION OF THE DRAWINGS

FIG. 1 is a block diagram of an example computing device, constructed in accordance with the teachings of this disclosure, to process resources according to a security policy based on automatically detecting a security environment in which the computing device is located.

FIG. 2 is a block diagram of an example implementation of the computing device of FIG. 1.

FIG. 3 illustrates an example set of resources that may be identified by a computing device to determine a current security environment.

FIG. 4 illustrates an example resource bounding topology to that may be used by a computing device to determine a security level.

FIG. 5 illustrates an example user interface that may be displayed on a computing device when content is being processed at a first security level based on the computing device being in a first security environment.

FIG. 6 illustrates an example user interface that may be displayed on the computing device of FIG. 5 when content is being processed at a second security level based on the computing device being in the first security environment.

FIG. 7 illustrates an example user interface that may be displayed on the computing device of FIG. 5 when content is being processed at a third security level based on the computing device being in a second security environment.

FIG. 8 illustrates an example user interface that may be displayed on the computing device of FIG. 5 to notify a user that an application is not usable when the computing device is in a particular security environment.

FIG. 9 is a flowchart representative of example machine readable instructions that may be executed to implement the example computing device of FIG. 1 to automatically, securely process data based on identifying a security environment.

FIG. 10 is a flowchart representative of example machine readable instructions that may be executed to implement the example computing device of FIG. 1 to provision secure data processing according to a security level.

FIG. 11 is a flowchart representative of example machine readable instructions that may be executed to implement the example computing device of FIG. 1 to process a resource according to a selected security level.

FIG. 12 is a block diagram of an example processor platform capable of executing the instructions of FIGS. 9, 10, and 11 to implement the computing device and/or the secure computing environment of FIGS. 1 and/or 2.

The figures are not to scale. Wherever appropriate, the same reference numbers will be used throughout the drawing(s) and accompanying written description to refer to the same or like parts.

### DETAILED DESCRIPTION

Example methods and apparatus disclosed herein enhance the reliability and efficacy of determining and enforcing security policies for data. Prior data security techniques required a user to select applicable security rules to be applied to a device for a particular situation, and these rules may change from location to location (e.g., when the device is mobile). Requiring the device user to manually select the security policy is only as reliable as the user, and results in more frequent violations of the applicable security policies.

As used herein, a security policy is defined as a set of data usage rules intended to control the use of data to achieve one or more goals. While some security policies are directed towards promoting confidentiality of data, other security policies may have a reduced emphasis on confidentiality in favor of other goals. Examples of such goals may include preventing conflicts of interest, ensuring data integrity and/or integrity in decision-making occurring based on the data, data loss prevention, and data availability, among others.

In contrast to prior techniques, example methods and apparatus disclosed herein collect information about the environment and circumstances in which the computing device is located, automatically determine the appropriate security policy for the environment and circumstances, and configure the computing device to enforce and/or comply with the security policy. For example, when the high security environment is detected based on a location of the computing device, the computing device may configure processing resources of the computing device to comply with a high security policy in force for the high security environment by: a) configuring communications to and/or from the computing device to have a higher level of security (e.g., encryption and decryption), b) provisioning one or more trusted execution environments within the processor of the computing device with a key that enables access to documents that require a similarly high level of security, and/or c) applying metadata or other security measures that match the high security level as a default security requirement for any new content generated by the device. In some examples, security policies are subject to exceptions made by authorized persons, in which case a different security level is applied within the scope of the exception.

As used herein, a security environment is defined as a set of circumstances that determine a specific security policy to be implemented. A security environment may include, for example, a specific location (e.g., a defined room, facility, building, geographic area, or the like), a type of location (e.g., a laboratory, a conference room, a factory, a public location, etc.), nearby persons (e.g., specific individuals), concurrent events (e.g., a meeting scheduled for a current time), and/or a current time and/or date.

As used herein, a classification level is defined as a selected one of a set of enumerated classifications that can be applied to content. In some examples, the enumerated classifications in the set are defined by an implementing body, such as a set of security classifications (e.g., unclassified, classified, secret, and top secret) being defined by an information security department of an organization.

As used herein, a trusted execution environment refers to a secure area of a processor that ensures that sensitive data is stored, processed, and protected in a trusted environment. An example of a trusted execution environment is a secure processing space defined using Software Guard Extensions (SGX), developed by Intel® Corporation.

As used herein, a trusted platform module refers to an implementation of a defined set of capabilities that provides authentication and attestation functionality for a computing device, and protects information by controlling access to plain-text data. Trusted platform modules are self-sufficient as a source of authentication and as a means of enhancing the protection of information from certain types of physical attacks.

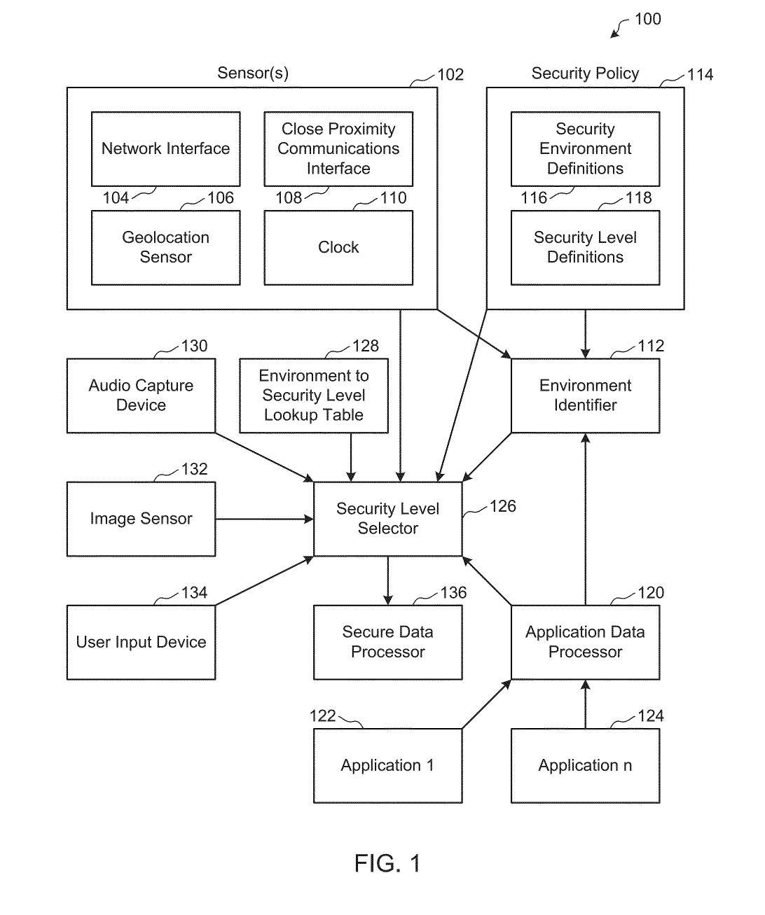

FIG. 1 is a block diagram of an example computing device 100 to process resources according to a security policy based on automatically detecting a security environment in which the computing device 100 is located. The example computing device 100 of FIG. 1 automatically detects a security environment based on one or more inputs, provisions a secure processing environment for data processing based on the security environment and a security policy. The computing device 100 processes data in the secure data processing environment according to the security policy. In some examples, the computing device 100 enforces the security policy until a change in the security environment is detected.

By automatically applying the appropriate security policy at a computing device, the example computing device 100 of FIG. 1 results in more reliability in enforcing security policies across an entire organization that includes large numbers of such computing devices (e.g., tens, hundreds, thousands, tens of thousands, hundreds of thousands, millions, or more devices). Furthermore, the example computing device 100 conserves processing resources by eliminating processing cycles associated with interacting with the user to set the appropriate security policy and enforcement.

The example computing device 100 of FIG. 1 includes one or more sensor(s) 102, which serve as information sources for determining a current security environment for the computing device 100. The sensor(s) 102 of FIG. 1 may serve functions (e.g., primary functions) in addition to providing information for determining the security environment. The example sensor(s) 102 of FIG. 1 include a network interface 104, a geolocation sensor 106, a close proximity communications interface 108, and a clock 110. However, other sensors may be used in addition or as an alternative to any of the sensors 102-110.

The example network interface 104 communicates with a local area network and/or a wide area network communication capabilities (e.g., IEEE 802.x communications). The example network interface 104 is the primary method of communications with other devices. The network interface 104 may provide an access point name, a local area network name, a service set identifier (SSID) for a wireless local area network, a media access control address of one or more devices connected to the local area network, and/or any other information that can be obtained by the network interface 104.

The example geolocation sensor 106 determines the location of the computing device. Example devices that may be used to implement the geolocation sensor 106 include global positioning system (GPS) receivers, assisted GPS (AGPS) receivers, wireless communications radios (e.g., via triangulation techniques and/or SSID-to-location mapping). The geolocation sensor 106 may have geolocation as a primary function (e.g., GPS receivers that determine coordinates of a current location) and/or as a secondary function (e.g., wireless communications radios that communicate, but can also triangulate a position based on known locations of radio towers).

The example close proximity communications interface 108 of FIG. 1 identifies other devices via close proximity communications techniques (e.g., near-field communications, Bluetooth communications, etc.). For example, the close proximity communications interface 108 may be intentionally used by a user of the computing device 100 when, for example, entering and/or exiting a physical area, such as scanning an entry/exit sensor with a near field communications interface. Additionally or alternatively, the example close proximity communications interface may be passively used by the computing device 100 to recognize and/or identify other devices using, for example, Low Energy Bluetooth communications. As described in more detail below, devices proximate to the computing device 100 may affect the security environment.

The example clock 110 provides a time and/or date for use in identifying the security environment. For example, the current time and/or date may be used in conjunction with other information, such as scheduled meeting information for the user of the computing device 100 and/or public meeting information for other people associated with the user of the computing device 100. In some other examples, the geolocation sensor 106 provides time and/or date information based on time and/or date data received via a geolocation source (e.g., GPS time and/or date information).

The example computing device 100 of FIG. 1 includes an environment identifier 112 to identify a security environment based on the inputs from the sensor(s) 102 and a security policy 114. As discussed in more detail below, the environment identifier 112 obtains a set of inputs and determines a current security environment. The example environment identifier 112 may repeatedly determine the security environment to identify when the security environment changes to enable timely changes to the security level applied by the computing device 100.

The example security policy 114 defines a set of security environment definitions 116 in which the computing device 100 could potentially be present. For example, the security environment definitions 116 identify a set of environments that may be explicitly defined by a controlling entity (e.g., an information security department of an organization, or the like), and a default or fallback environment. The security environment definitions 116 include a set of rules (e.g., environment definitions) that state the conditions under which the computing device is to be considered in that particular security environment.

For example, a security environment definition 116 may be defined by a specific set of one or more geographic locations, a present connection to one or more communications networks, and/or access points, the close proximity of one or more specified other computing devices (e.g., the presence of a specified computing device, such as the mobile phone of the organizations chief executive officer, within a threshold distance of the computing device 100), occurring simultaneously with another event, and/or any other conditions. The security environment definitions 116 may be defined using rules that are conjunctive (e.g., multiple conditions related by a logical AND operator), disjunctive (e.g., multiple conditions related by a logical OR operator), mutually exclusive (e.g., multiple conditions related by an exclusive-OR (XOR) operation), and/or using any other method of defining such rules.

The example security policy 114 of FIG. 1 also includes a set of security level definitions 118. The security levels are selected based on the identified security environment. Each of the example security level definitions 118 specifies a set of operating conditions under which the computing device 100 is constrained for accessing and/or using data when that security level is the current security level (e.g., an active security level). For example, when a “medium security” level is active, the example security level definitions 118 specify that the computing device 100 is required to encrypt and/or tag newly generated content at a medium security encryption level, restrict access to data that is classified at higher security levels than the “medium security” level, and/or restrict the types of use of data on the computing device (e.g., restrict downloading and storage of data but permit ephemeral uses of the data at the computing device 100).

The example security environment definitions 116 and the example security level definitions 118 of FIG. 1 cover all possible situations or circumstances in which the computing device 100 can be located. In some examples, the security environment definitions 116 define default security environment(s) that are identified when no other defined security environment is applicable. All of the example security environment definitions 116 of FIG. 1 are mapped to one of the security level definitions 118, where any of the security level definitions may be selected for more than one of the defined security environments.

In addition to data from the sensors 102, the example computing device 100 includes an application data processor 120 to provide information describing the activities of applications 122, 124 executing on the computing device 100. The example environment identifier 112 of FIG. 1 receives application data from the application data processor 120 and determines the security environment based on the application data and the data obtained from the sensors 102. The application data processor 120 may further determine data describing the system attributes, such as the identity of the logged-in user.

Example applications 122, 124 from which the application data processor 120 may extract information include calendar software (e.g., Microsoft® Outlook®, Lotus Notes®, Google Calendar™), data loss prevention software, and/or data management software (e.g., Microsoft® SharePoint®, Huddle®, etc.). For example, the application data processor 120 may extract meeting information from calendar software, such as scheduled time, location, participants, file attachments, and/or any other data describing the circumstances of the meeting. Such meeting information may be used by the environment identifier 112 (e.g., in conjunction with the time and date from the clock 110) when identifying the current security environment. In some examples, the application data processor 120 uses data from a data loss prevention application, such as the use of a virtual private network and/or a current status of the computing device determined by the data loss prevention application, to determine the current security environment (e.g., alone or in combination with other information). In some examples, the application data processor 120 uses a connection status to a shared data source (e.g., the presence of an open connection to a shared data server, which may be classified at one or more security levels) to determine the current security environment (e.g., alone or in combination with other information).

The example environment identifier 112 compares the data obtained from the sensors 102 and/or from the application data processor 120 to the security environment definitions 116 to determine a current security environment for the computing device 100. In some examples, the security policy 114 stores and/or accesses the security environment definitions 116 as a lookup table. In such examples, the environment identifier 112 searches the lookup table using combinations of one or more present conditions until a dominating security environment is located. Additionally or alternatively, the security policy 114 stores and/or accesses the security environment definitions 116 as a flowchart or algorithm in which conditions and/or combinations of conditions (e.g., from the sensors 102) are specified as a set of steps or instructions to be performed, with the resulting output being the current security environment. The environment identifier 112 tests the flowchart(s) and/or algorithm(s) programmatically using data obtained from the sensors 102 until a security environment is identified. The example computing device 100 includes a security level selector 126 to determine which of the security level definitions 118 is to be applied to the computing device 100 based on the identified security environment. The example security level selector 126 receives an identification of the security environment from the environment identifier 112 and accesses the set of security level definitions 118.

The security level selector 126 of FIG. 1 determines the applicable one of the security levels 118 by, for example, looking up the identified security environment in a lookup table 128 that maps security environment(s) (e.g., security environments defined in the security environment definitions 116) to security levels (e.g., the security levels defined in the security level definitions 118). The example security level selector 126 applies the corresponding security level to data being accessed and to data (e.g., content) that is generated at the computing device 100 while the security level is active. Resources (e.g., software) that are subject to the applied security level(s) are referred to herein as subordinate resources.

To generate data (e.g., content) at the computing device 100, the example computing device 100 includes input devices including an audio capture device 130 (e.g., a microphone), an image sensor 132 (e.g., a camera), and a user input device 134 (e.g., a touchscreen, a keyboard, a mouse, etc.). The example audio capture device 130 generates audio data by capturing ambient sound and converting the ambient sound to a digital representation. The example image sensor 132 captures and stores still images and/or video. The example user input device 134 may be used to enter text data, enter information freehand (e.g., handwritten signatures, hand drawings, etc.), interact with applications that control and/or manipulate the audio capture device 130 and/or the image sensor 132, and/or select data for viewing. The example computing device 100 may include any combination of hardware, software, and/or firmware to implement content-generating input devices.

In some examples, the security level selector 126 determines the security level to be applied on a case-by-case basis, even when there is a security level that has been determined based on the current security environment. For example, the security level selector 126 may apply a default security level to content generated using the audio capture device 130, the image sensor 132, and the user input device 134. In some cases, the example security level selector 126 applies a heightened security level (e.g., more restrictive) to one or more types of content input from the input devices 130-134.

For example, because the image sensor 132 is capable of capturing and storing large amounts of information in a short period of time (e.g., by taking a high-resolution photo or video of one or more documents, which could include content not intended by the user to be captured), the security level selector 126 may select or apply a heightened security level for content generated using the image sensor, relative to background security level that is selected based on the current security environment determined by the environment identifier 112. Because the example image sensor 132 is not aware of changes in a security environment, the security level selector 126 determines the appropriate security level for the image sensor 132 (e.g., based on the security policy 114). For example, the security level selector 126 may apply a “high security” level (e.g., a high security tag or metadata, depending on the security model being used) to content generated via the image sensor 132 even when the security level selector 126 applies a “medium security” level (e.g., tag or metadata) for other content based on the identified security environment). In some examples, the security level selector 126 selectively applies such different security levels. For example, even though the security level selector 126 raises the security level applied to generated images to “high security” when “medium security” is the active security level, the security level selector 126 applies the same “low security” level to generated images when the active security level is “low security.”

Conversely, the example security level selector 126 may apply a lower security level to content generated by one or more of the input devices 130-134 than the security level determined based on the security environment. For example, the security level selector 126 may apply a lower security level to content generated using the user input device 134, such as a keyboard.

In some examples, the security level selector 126 processes data using a security level that is different than the identified security level based on, for example, an application or type of software used to access or generate the data. For example, when software is used to access a public web site to download information while the security level corresponding to the current security environment is “high security,” the security level selector 126 may apply a lower security level to data accessed from the public web site.

In some examples, the example security level selector 126 enforces the security level by configuring restrictions on the input devices 130, 132, 134. For example, the security level definitions 118 may require the security level selector 126 to disable the audio capture device 130 and/or the image sensor 132, limit an amount of video and/or audio that can be captured at a time, reduce an image resolution, disable geotagging of captured images, and/or place any other restrictions on the input devices 130-134.

To enforce the security level for data access and/or content generation, the example computing device 100 includes a secure data processor 136. The example secure data processor 136 maintains or is securely provided with a set of access keys (e.g., encryption keys) that are required to access data that is secured at different security levels. The example secure data processor 136 includes one or more secure execution environments in which computing instructions may be executed and/or data may be stored in a protected manner (e.g., secure from interception, unauthorized access, or unauthorized use).

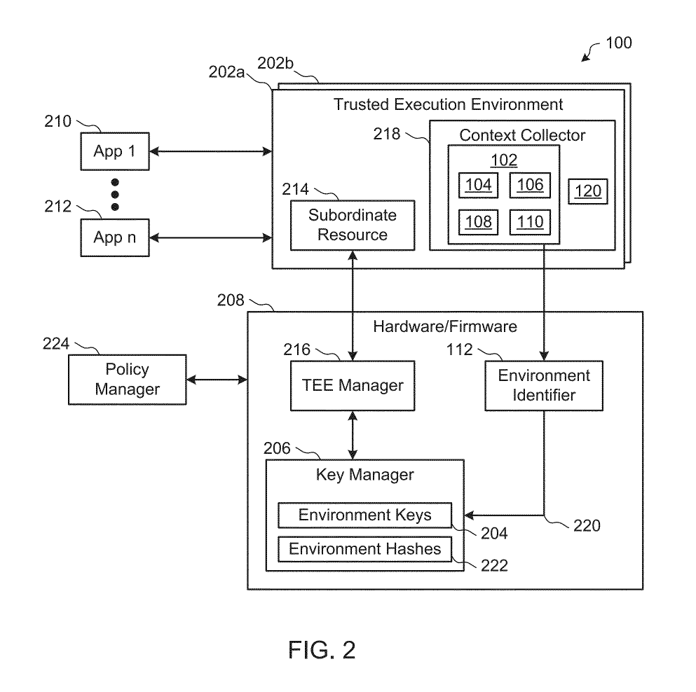

FIG. 2 is a block diagram of an example implementation of the computing device 100 of FIG. 1. In the example of FIG. 2, the computing device 100 accesses and/or processes data according to restrictions required by a security level (e.g., as defined in the security level definitions 118 of FIG. 1). In the example implementation of FIG. 2, a trusted execution environment 202a, 202b uses protected environment keys 204 to access data. As described in more detail below, a key manager 206 could be trusted to manage the environment keys 204, where use is permitted by the key manager 206 in response to an assertion of the corresponding environment level by the trusted execution environment 202a, 202b and evaluated by the environment identifier 112.

The example computing device 100 of FIG. 2 includes one or more trusted execution environments 202a, 202b and underlying hardware 208. In some examples, one or more features of the hardware 208 are at least partially implemented in firmware. The example trusted execution environments 202a, 202b implement the secure data processor 136 of FIG. 1 to securely process data based on a security level determined by the key manager 206. The key manager 206 may implement the security level selector 126 of FIG. 1 by determining a security level based on an identified environment. While the computing device 100 of FIG. 1 provides a secure processing and/or data storage environment, in some examples the secure data processor 136 is also capable of provide insecure data processing and/or data storage when secure data processing and/or data storage are not required.

The example trusted execution environment 202a may be instantiated or provisioned by the hardware/firmware 208 in response to a determination by the security level selector 126 (e.g., the key manager 206) that a particular security level is to be applied. In some examples, the hardware/firmware 208 of FIG. 2 provisions the trusted execution environments 202a, 202b using Software Guard Extensions (SGX), which permit an application to instantiate a protected container that provides confidentiality and integrity to instructions and data executed within the container. However, other methods of implementing the trusted execution environments 202a, 202b may additionally or alternatively be used. In some other examples, the hardware/firmware 208 of FIG. 2 instantiates one or more trusted execution environments 202a, 202b in response to a request from an application 210, 212 (e.g., an application executing on the computing device).

After instantiation, a subordinate resource 214 execute instructions to process data within the example trusted execution environment 202a of FIG. 2 processes in a manner that protects instructions and data from access by unauthorized applications or processes. The example subordinate resource 214 of FIG. 2 is only capable of accessing data in compliance with the applicable security level, because only environment keys 204 corresponding to the security level are released to the trusted execution environment 202a for use by the subordinate resource 214. Data that cannot be read using a released key is not accessible.

To handle requests for secure processing environments (e.g., SGX instructions), the example hardware/firmware 208 of FIG. 2 includes a trusted execution environment (TEE) manager 216. The TEE manager 216 of FIG. 2 receives requests to instantiate trusted execution environments 202a, 202b and services requests to provision the trusted execution environments 202a, 202b with applicable environment keys 204 to process data while enforcing the applicable security level. The example hardware/firmware 208 of FIG. 2 also includes a key manager 206 to securely store the environment keys 204 and to provide the environment keys 204 to the trusted execution environments 202a, 202b.

The example key manager 206 of FIG. 2 is a secured storage and/or processing environment that stores the environment keys 204 in a manner that is resistant to breaking, such as a Trusted Platform Module. To enable the key manager 206 to release the environment keys 204 to the trusted execution environments 202a, 202b, the example environment identifier 112 receives an assertion of a security level by the trusted execution environments 202a, 202b. For example, the trusted execution environment 202a may assert a “high security” level to process data tagged with a “high security” tag. The assertion of the security level includes data from a context collector 218 (e.g., to support the assertion that the asserted security level corresponds to the current security environment). The context collector 218 of FIG. 2 obtains data from one or more of the sensors 102-110 and/or from the application data processor 120 of FIG. 1. The example context collector 218 of FIG. 2 securely accesses the data within the trusted execution environment 202a from the sensors 102-110 and/or the application data processor 120 so that the combination of values cannot be identified by unauthorized software (e.g., to prevent a replay attack from defeating the security policy). The example environment identifier 112 obtains the context data from the context collector 218 and determines a current security environment based on the context data (e.g., via a lookup query, via a flowchart, etc.).

In the example of FIG. 2, the environment identifier 112 converts the identified security environment to a hash value 220 and outputs the hash value 220 to the key manager 206. The example key manager 206 compares the hash value 220 output by the environment identifier 112 to a set of environment hashes 222. When the hash value 220 is matched to one of the environment hashes 222, the example key manager 206 releases any environment key(s) 204 that are authorized in association with the matching environment hash 222 for provision by the TEE manager 216 to the trusted execution environment 202a. For example, if the matching environment hash 222 authorizes the use of one or more of the environment keys 204 that correspond to a “medium security” level, the key manager 206 releases those environment keys 204 to the example trusted execution environment 202a via the TEE manager 216. The example subordinate resource 214 (e.g., executing within the trusted execution environment 202a) that is attempting to access data secured at a “medium security” level may use the released keys 204 to access the “medium security” data.

Depending on the security policy 114, the example key manager 206 may be configured to release environment keys 204 that have a matching security level and/or a less restrictive security level than the matched environment hash 222. In some examples, keys for different security levels (e.g., “low security” and “high security”) are provisioned to the same trusted execution environment 202a when released by the key manager 206. In some other examples, keys for different security levels (e.g., “low security” and “high security”) are provisioned to different trusted execution environments 202a, 202b when released by the key manager 206. In such cases, an application or process that wishes to access data having different security levels is required to access data at a first security level via a first one of the trusted execution environments 202a and access data at a second security level via a second one of the trusted execution environments 202b.

In the example of FIG. 2, the key manager 206 is requested to release the environment keys 204 when the subordinate resource 214 requests access to data that is subject to the security policy 114 of FIG. 1. In some examples, access to the environment keys 204 by the trusted execution environments 202a, 202b is revoked when the access is no longer needed. In some such examples, the trusted execution environments 202a, 202b are maintained even when authorization to access the environment keys 204 is revoked by the key manager 206 via the TEE manager 216 (e.g., when the environment identifier 112 identifies a different security environment and the hash 220 no longer matches an environment hash 222 that authorizes use of the environment keys 204). In some other examples, the trusted execution environments 202a, 202b persist only while use of the environment keys 204 is authorized, and are decommissioned when the key manager 206 revokes access to the environment keys 204 via the TEE manager 216.

In the example of FIG. 2, the hardware/firmware 208 communicates with a policy manager 224 (e.g., via a communications network, a hardware interface, etc.). The policy manager 224 stores a security policy (e.g., the security policy 114, including the security environment definitions 116 and the security level definitions 118) that is referenced and/or otherwise used by the hardware/firmware 208 to enforce the security policy 114. The example policy manager 224 of FIG. 2 further includes the environment to security level lookup table 128 of FIG. 1. The example environment identifier 112 and/or the key manager 206 communicate with the policy manager 224 to obtain updated security environment information and/or security level information. In some examples, the key manager 206 communicates with the policy manager 224 via a secure channel to avoid compromising the security and/or trust of the key manager 206.

The example policy manager 224 may be updated periodically or aperiodically with changes to the security environment definitions 116 and/or the security level definitions 118. For example, the policy manager 224 may communicate with a security policy server of an organization to receive security updates, which the policy manager 224 then provides to the key manager 206 and/or the environment identifier 112.

In some examples, the policy manager 224 is a component of the hardware/firmware 208. For example, the policy manager 224 may be implemented as a hardware or firmware element of the computing device 100. Such an implementation reduces the flexibility of the policy manager 224 and makes both authorized and unauthorized modifications to the policy manager 224 more complicated (e.g., by reducing the mechanisms through which the policy manager 224 may be modified and/or reducing the aspects of the policy manager 224 that may be modified).

While an example manner of implementing the computing device 100 of FIG. 1 is illustrated in FIG. 2, one or more of the elements, processes and/or devices illustrated in FIGS. 1 and 2 may be combined, divided, re-arranged, omitted, eliminated and/or implemented in any other way. Further, the example sensors 102, the example network interface 104, the example geolocation sensor 106, the example close proximity communications interface 108, the example clock 110, the example environment identifier 112, the example application data processor 120, the example applications 122, 124, 210, 212, the example security level selector 126, the example environment to security level lookup table 128, the example audio capture device 130, the example image sensor 132, the example user input device 134, the example secure data processor 136, the example trusted execution environments 202a, 202b, the example key manager 206, the example hardware/firmware 208, the example subordinate resource 214, the example TEE manager 216, the example context collector 218, the example policy manager 224 and/or, more generally, the example computing device 100 of FIGS. 1 and/or 2 may be implemented by hardware, software, firmware and/or any combination of hardware, software and/or firmware. Thus, for example, any of the example sensors 102 the example network interface 104, the example geolocation sensor 106, the example close proximity communications interface 108, the example clock 110, the example environment identifier 112, the example application data processor 120, the example applications 122, 124, 210, 212, the example security level selector 126, the example environment to security level lookup table 128, the example audio capture device 130, the example image sensor 132, the example user input device 134, the example secure data processor 136, the example trusted execution environments 202a, 202b, the example key manager 206, the example hardware/firmware 208, the example subordinate resource 214, the example TEE manager 216, the example context collector 218, the example policy manager 224 and/or, more generally, the example computing device 100 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example sensors 102, the example network interface 104, the example geolocation sensor 106, the example close proximity communications interface 108, the example clock 110, the example environment identifier 112, the example application data processor 120, the example applications 122, 124, 210, 212, the example security level selector 126, the example environment to security level lookup table 128, the example audio capture device 130, the example image sensor 132, the example user input device 134, the example secure data processor 136, the example trusted execution environments 202a, 202b, the example key manager 206, the example hardware/firmware 208, the example subordinate resource 214, the example TEE manager 216, the example context collector 218, and/or the example policy manager 224 is/are hereby expressly defined to include a tangible computer readable storage device or storage disk such as a memory, a digital versatile disk (DVD), a compact disk (CD), a Blu-ray disk, etc. storing the software and/or firmware. Further still, the example computing device 100 of FIGS. 1 and/or 2 may include one or more elements, processes and/or devices in addition to, or instead of, those illustrated in FIGS. 1 and/or 2, and/or may include more than one of any or all of the illustrated elements, processes and devices.

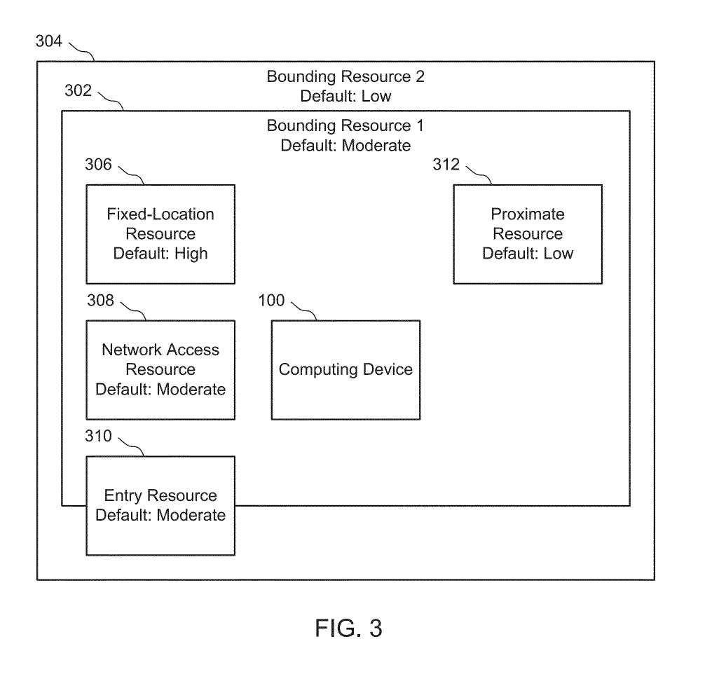

FIG. 3 illustrates an example set of resources 302-312 that may be identified by the computing device 100 of FIGS. 1 and/or 2 to determine a current security environment. The example resources 302-312 may be represented in the security environment definitions 116 of FIG. 1, in that the current relationship between the computing device 100 and each of the example resources 302-312 affects the determination of the security environment by the environment identifier 112.

In the example of FIG. 3, the resources 302-312 have respective default security levels (e.g., one of the security levels defined in the security level definitions 118 of FIG. 1), which are indicated in FIG. 3. The default security levels of the resources 302-312 indicate a default security level that the computing device 100 would be expected to apply if the corresponding resource 302-312 was a controlling or dominating factor in determining the security environment.

The example bounding resources 302, 304 are virtual manifestations of defined physical areas, such as designated rooms, sectors, buildings, campuses, geographical areas, and/or any other type of physical space. In the example of FIG. 3, the computing device 100 is located within a first bounding resource 302, which in turn is located within a second bounding resource 302. The example computing device 100 may recognize that it is located within the bounding resource 302, 304 based on data from the geolocation sensor 106.

In the example of FIG. 3, a fixed-location resource 306 is located within the bounding resource 302 and is substantially fixed to that location. For example, the fixed-location resource 306 may be a computing device or accessory (e.g., a storage device, a display device such as a monitor or projector, etc.) that is physically affixed to a location within the bounding resource 302. The example computing device 100 recognizes that it is proximate to the fixed-location resource 306 based on being on a same network subnet as the fixed-location resource 306, by receiving descriptive metadata from the fixed-location resource 306 via a short-range wireless communication, receiving metadata via a direct physical connection (e.g., when the computing device 100 and the fixed-location resource 306 are connected via a physical connection), and/or any other method of proximity recognition.

The example network access resource 308 provides an access point within the bounding resource 302 for communication with a network. For example, the network access resource 308 may be a wireless access point or router, a wired router having accessible ports within the bounding resource 302, a gateway device that controls communications between a network access device, or any other network access resource. In the example of FIG. 3, the network access resource 308 is restricted to the bounding resource 302, but in other examples the network access resource 308 is not so limited and may span multiple bounding resources 302, 304. The example computing device 100 recognizes the network access resource 308 by identifying a MAC address of the network access resource 308 and/or based on metadata describing the network access resource (e.g., an SSID).

The example entry resource 310 of FIG. 3 may include, for example, an entry scanner that controls and/or identifies devices entering and/or exiting the physical location corresponding to the bounding resource 302. The entry resource 310 may connect with the computing device 100 via, for example, close proximity communications such as NFC to exchange credentials and/or identification. The example computing device 100 likewise recognizes the entry resource 310 at the time of entering the physical area (corresponding to the bounding resource 302) via the entry resource 310.

The example proximate resource 312 may be any type of resource (e.g., device) capable of short-range wireless transmission. For example, the proximate resource 312 may be another computing device, such as a mobile device, laptop computer, or tablet computer, that is brought within a proximity range and then out of the proximity range (e.g., by movement of the computing device 100 and/or by movement of the proximate resource 312).

In the example of FIG. 3, the computing device 100 updates a security environment each time one of the resources 302-312 is recognized For example, as the computing device 100 enters the physical area of the bounding resource 302 (e.g., from the bounding resource 304), the computing device 100 recognizes the entry resource 310 via an NFC communication. Additionally or alternatively, the computing device 100 recognizes the bounding resource 302 based on determining the geolocation of the computing device 100 and/or as an implication of the communication with the entry resource 310. The computing device 100 makes a determination of the security environment based identifying the bounding resource 302 and the entry resource 310.

At a later time, the computing device 100 recognizes the fixed-location resource 306 (e.g., when the computing device is plugged into the fixed-location resource 306), the network access resource 308 (e.g., when the computing device 100 connects to the network access resource 308), and the proximate resource 312 (e.g., when the proximate resource 312 enters the area and is recognized via short-range wireless communications). Each time the computing device 100 recognizes one of the resources 306, 308, 312, the computing device 100 updates the calculated security environment and the corresponding security level. Referring to the example implementation of FIG. 2, the computing device 100 provisions and/or revokes environment keys 204 from trusted execution environments 202a, 202b as the security environment changes.

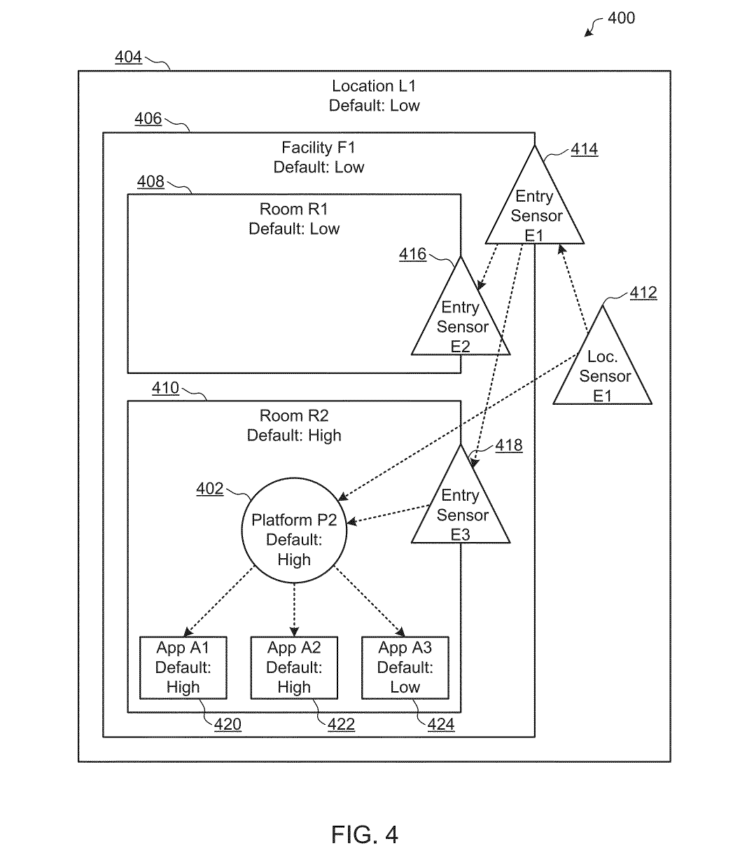

FIG. 4 illustrates an example resource bounding topology 400 that may be used by a platform 402 to determine a security level. The example resource bounding topology 400 includes a hierarchy in which resources are assigned a default security level that is used by the platform 402 to determine a default security level under which the platform 402 is to operate when processing data.

The example resource bounding topology 400 includes a location 404, which includes a facility 406. The example facility 406 includes two rooms 408, 410. The location 404, the facility 406, and the rooms 408, 410 are therefore nested, such that the rooms 408, 410 are within both the facility 406 and the location 404. The location 404, the facility 406, and the rooms 408, 410 are example designations given to these nested physical areas 404-410, and are not limited to these designations. The example location 404, the example facility 406, and the example rooms 408, 410 are represented by corresponding logical entities in a database. The database of logical entities is stored in a storage device at, for example, the computing device 100 (e.g., as part of the security environment definitions 116) and/or at a storage location controlled by the organization that defines the security policy 114.

The example resource bounding topology 400 further includes a location sensor 412. The example location sensor 412 corresponds to the location 404 such that, when the location sensor 412 is detected by the platform 402, the platform 402 determines that it is located within the bounds of the location 404. Similarly, the example resource bounding topology 400 of FIG. 4 includes entry sensors 414, 416, 418, that respectively correspond to the facility 406, the room 408, and the room 410. The entry sensors 414, 416, 418 monitor and/or control entry and/or exit for the facility 406, the room 408, and the room 410 by the platform 402 (and other computing devices).

The example platform 402 detects the entry sensor 414 when the platform 402 enters and/or exits the facility 406, detects the entry sensor 416 when the platform 402 enters and/or exits the room 408, and detects the entry sensor 418 when the platform 402 enters and/or exits the room 410. In this manner, the example platform 402 may update the security environment of the platform 402 in response to detection of any of the sensors 412, 414, 416, 418. For example, the platform 402 may detect the sensors 412-418 using the network interface 104 (e.g., by recognizing an SSID of a wireless LAN) and/or the close proximity communications interface 108 (e.g., by tapping the entry sensors 414-418 using an NFC interface, by recognizing the entry sensors 414-418 using Bluetooth Low Energy while passing near the entry sensors 414-418, etc.).

The example platform 402 executes multiple applications 420, 422, 424. In the example of FIG. 4, the platform 402 applies the default security level to data processing performed by the applications 420-424 (e.g., data access, data creation, etc.) unless an overriding security level is enforced. An example overriding security level is described in more detail below.

The example location sensor 412 of FIG. 4 has a default security level LOW for devices within the location 404. However, the entry sensor 418 applies an override policy to apply a security level HIGH to the room 410. Because the platform 402 is in the room 410 and in the location 404 (e.g., determined via the location sensor 412), the platform 402 has conflicting information regarding the appropriate default security level to be applied. The entry sensor 418 asserts a HIGH security level while the location sensor 412 asserts a LOW security level. The example platform 402 of FIG. 4 uses the security policy (e.g., the security policy 114, the security environment definitions 116, and/or the security level definitions 118 of FIG. 1) to resolve conflicts. In the example of FIG. 4, the HIGH security level implies that an information confidentiality policy is applicable to data access by the platform 402 and, therefore, the HIGH security level dominates or overrides the LOW security level. As a result, the platform 402 protects less sensitive information at the HIGH security level.

In the example of FIG. 4, the platform 402 (e.g., the computing device 100 of FIGS. 1 and/or 2) may override default security levels. For example, an authorized individual may elevate a security level using the platform 402 according to the rights or privileges granted to that individual (or to the organizational role assigned to that individual) by the organization that defines the security policy. An elevated privilege overrides the outer default and becomes the new default level for any resources that are bounded by the overridden resource. For example, if the platform 402 is overridden, the applications 420-424 are similarly overridden by virtue of being subordinate to the platform 402. However, overriding the application 424 does not affect the platform 402 or the applications 420, 422 without some other relationship that would cause the platform 402 and/or the applications 420, 422 to be subordinate to 424.

In the example of FIG. 4, an administrative action overrides the default security level for subordinate resources (such as the applications 420-424). For example, while the default security level applied to the platform 402 is the HIGH security level (e.g., due to the security level assigned based on the entry sensor 418 and/or the room 410), an administrative action at the platform 402 causes the application 424 to be overridden and reclassified as the LOW security level. However, in some examples such overriding of the applied security level is an infrequent or exceptional case. Rather, the example platform 402 operates to improve usability by automatically applying or enforcing the appropriate security level for data processing, based on detecting a current security environment, to comply with a data security policy.

When a subordinate resource (e.g., the platform 402, the applications 420-424) moves from one security environment (e.g., the room 410) to a second security environment (e.g., the room 408, the facility 406), the second security environment (e.g., the room 408, the entry sensor 416) becomes the dominating resource that is inherited by the subordinate resource (e.g., the platform 402, the applications 420-424) if the security policy allows this relationship. Furthermore, inheritance of security levels may cascade (e.g., from the location 404 to the rooms 408, 410 via the facility 406).

In some examples, physical movement of a physical subordinate resource (e.g., the platform 402) into a foreign environment (e.g., from inside of the room 410 to the facility 406 outside of the room) may be prevented so as not to violate the policy. For example, the entry sensor 418 may prevent the platform 402 from exiting the room 410 when permitting such an exit would allow inheritance of a lower security level at the platform 402 from the bounding facility F1 security level of LOW when the data on the platform 402 is not properly protected. The platform 402 may be prevented from exiting the room 410 while data generated within the room 410 (e.g., at the HIGH security level) is not yet secured at the security level required by the security policy (e.g., has not yet been encrypted using an environment key corresponding to the HIGH security level).

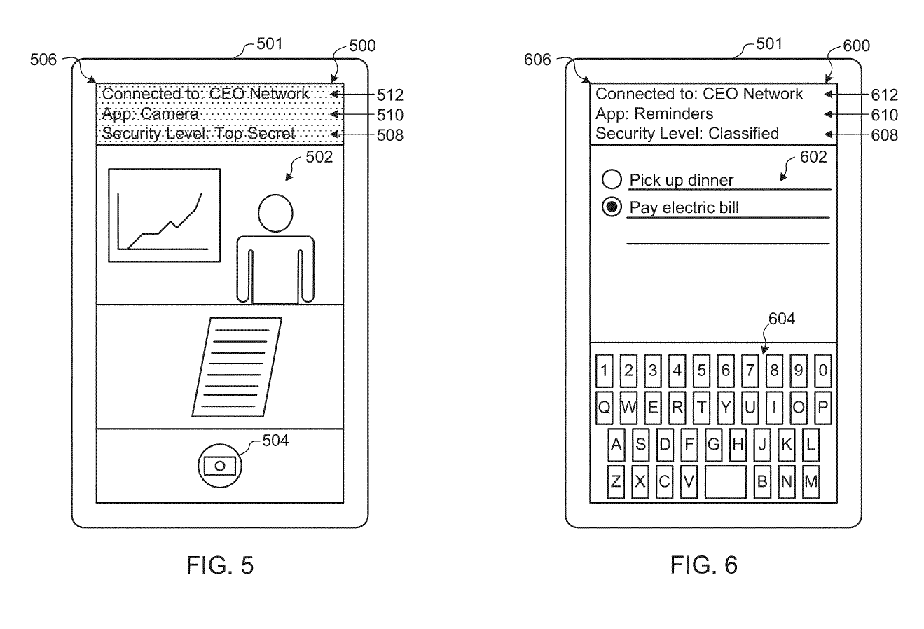

FIG. 5 illustrates an example user interface 500 that may be displayed on a computing device 501 when content is being processed at a first security level based on the computing device being in a first security environment. The example computing device 501 may be the computing device 100 of FIGS. 1 and/or 2. For example, the computing device 501 shown in FIG. 5 is a smartphone executing a camera application.

The example user interface 500 displays a preview image 502 based on input from an image sensor (e.g., the image sensor 132 of FIG. 1). The user interface 500 further includes an image capture button 504 that causes the computing device 100 to capture an image using the image sensor 132.

The example user interface 500 of FIG. 5 further includes a security level indicator 506. The example security level indicator 506 displays information that indicates a current security level 508 (e.g., determined by the security level selector 126 of FIG. 1), data currently being processed 510 (e.g., an identifier of an application that is generating or accessing data), and an indication of the security environment 512 (e.g., an identification of one or more dominating factors in determining the security environment, or an identification of the security environment itself).

The example user interface 500 of FIG. 5 shows that the current security level is “Top Secret.” The computing device 501 determines the security level as described above with reference to FIGS. 1 and/or 2. For example, the example security level selector 126 determines the “Top Secret” security level based on a security environment identified by the environment identifier 112 (e.g., using the environment to security level lookup table 128 of FIG. 1 and/or the environment hashes of FIG. 2). The environment identifier 112 determines the security environment based at least in part on the network interface 104 providing information that the computing device is connected to a wireless network having an SSID of “CEO Network” as shown in the indication of the security environment 512 of FIG. 5.

As the example camera application generates data (e.g., images), the example computing device 501 (e.g., via the secure data processor 136 of FIG. 1) applies restrictions to the generated data that are required based on the “Top Secret” security level. For example, the secure data processor 136 may automatically perform encryption of the data and/or apply metadata “tags” indicating that the generated data is required to be protected at the “Top Secret” security level.

FIG. 6 illustrates an example user interface 600 that may be displayed on the computing device 501 of FIG. 5 when content is being processed at a second security level based on the computing device 501 being in the first security environment 512. In the illustrated example of FIG. 6, the user interface 600 is showing a “reminders” application 602 that stores text-based notes entered by the user (e.g., via the user input device 134 of FIG. 1, such as a touchscreen or physical keyboard 604) and may alert the user based on the reminders.

In the example of FIG. 6, the computing device 501 remains in the same security environment as determined by the computing device 501 in the example of FIG. 5 (e.g., which is based on and/or dominated by the connection to the “CEO Network” resource). Like the user interface 500 of FIG. 5, the example user interface 600 includes a security level indicator 606 displays information that indicates a current security level 608 (e.g., determined by the security level selector 126 of FIG. 1), data currently being processed 610 (e.g., an identifier of an application that is generating or accessing data), and an indication of the security environment 612, which is the same as the security environment of the example of FIG. 5.

In the example of FIG. 6, the security level for the reminders application 602 has been reduced by the computing device 501 (e.g., via the security level selector 126 based on the security policy 114 of FIG. 1 and/or input from the user). For example, the security level selector 126 determines that an overriding security level has been applied by the user (e.g., a user who is authorized to make such a change) such that the security level 608 for the reminders application 602 is reduced (e.g., made less restrictive) from “Top Secret” (as required by the security environment) to “Classified.” When content is generated using the reminders application 602 in the security environment 612, the example secure data processor 136 automatically processes the data using the requirements of the “Classified” security level. In the example of FIG. 6, these requirements may include a less computationally-intensive encryption process than the encryption process required under the “Top Secret” security level, and/or a simple tagging of the generated data as protected under the “Classified” security level.

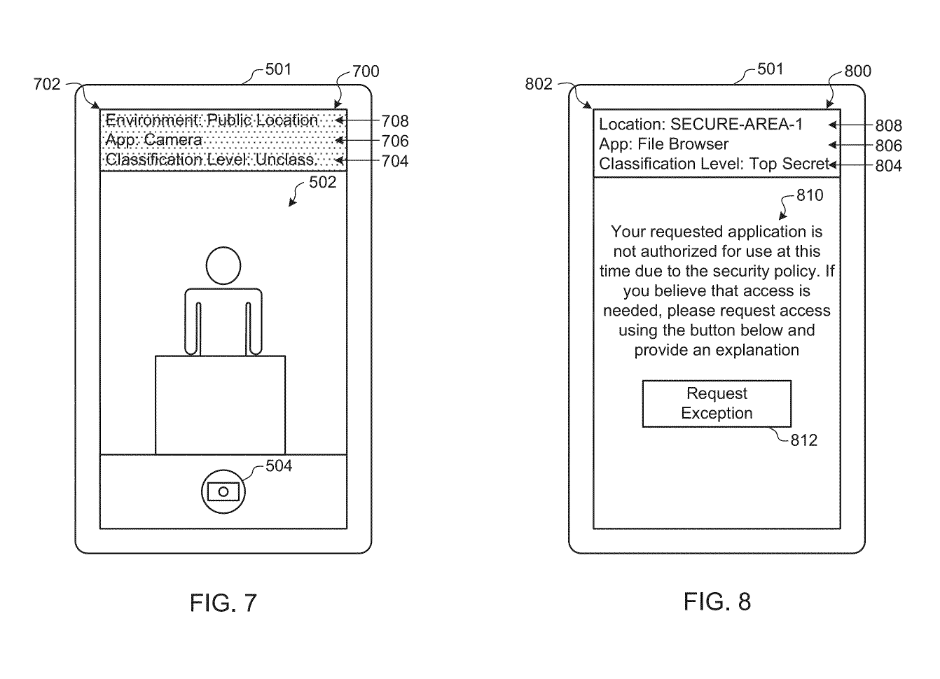

FIG. 7 illustrates an example user interface 700 that may be displayed on the computing device 501 of FIGS. 5 and 6 when content is being processed at a third security level based on the computing device 501 being in a second security environment. In the example of FIG. 7, the computing device 501 is executing the same camera application 502 as in the example of FIG. 5, which has the image capture button 504.

As in the examples of FIGS. 5 and 6, the example user interface 700 of FIG. 7 includes a security level indicator 702. The example security level indicator 702 of FIG. 7 includes a current security level 704 (e.g., determined by the security level selector 126 of FIG. 1), data currently being processed 706 (e.g., an identifier of an application that is generating or accessing data), and an indication of the security environment 708 (e.g., an identification of one or more dominating factors in determining the security environment, or an identification of the security environment itself).

The computing device 501 (e.g., via the environment identifier 112 of FIG. 1) identifies the security environment in the example of FIG. 7 based on, for example, geolocation information from the geolocation sensor 106, network connection information from the network interface 104 (e.g., a connection to a publicly-accessible WiFi network in a cafe, a connection to a wireless communications system using 3GPP or LTE communications, etc.), and/or a lack of security-heightening factors from the application data processor 120. The security level indicator 702 of FIG. 7 indicates that the security environment 708 is a public location. The example security level selector 126 then uses the environment to security level lookup table 128 to determine that the corresponding security level 704 is an “Unclassified” security level.

In the example of FIG. 7, the secure data processor 136 does not need to secure generated data based on the accessed security policy. However, the user of the example computing device 501 may manually elevate the security level 704 to protect newly-generated content at the computing device 501.

Additionally or alternatively, if the computing device 501 is used to access data classified at a higher security level (e.g., from a server via a network connection), while other circumstances or context remains the same (e.g., at the same public location), the example environment identifier 112 may change the security environment based on use of data protection software such as a VPN connected to the data server. In response, the example security level selector 126 increases the security level and the secure data processor 136 securely accesses the data (e.g., as described above with reference to FIG. 2).

FIG. 8 illustrates an example user interface 800 that may be displayed on the computing device 501 of FIGS. 5, 6, and 7 to notify a user that an application is not usable when the computing device 501 is in a particular security environment.

The example user interface 800 includes a security level indicator 802 that includes a current security level 804 (e.g., determined by the security level selector 126 of FIG. 1), an application currently being used to process data 806, and an indication of the security environment 808. In the example of FIG. 8, the computing device 501 (e.g., via the environment identifier 112 of FIG. 1) has identified the security environment based on being located in “SECURE-AREA-1.” For example, the environment identifier 112 may identify the “SECURE-AREA-1” environment based on being connected to a wired or wireless network (e.g., via the network interface 104), a geolocation measurement (e.g., from the geolocation sensor 106), detection of an entry sensor to the physical area (e.g., via the close proximity communications interface 108), and/or via a combination of calendar data (e.g., a meeting indicating that the meeting was to occur at the secure area, via the application data processor 120) and clock data (e.g., from the clock 110).

In the example of FIG. 8, a user of the computing device 501 has requested access to a document that is not authorized for use based on the current security level. For example, the trusted execution environments 202a, 202b of FIG. 2 may be unable to decrypt the desired file using any of the environment keys 204 released to the trusted execution environments 202a, 202b by the key manager 206 (e.g., environment keys 204 released based on comparing the environment hashes 222 to the hash 220 obtained from the environment identifier 112). The user interface 800 displays a message 810 to inform the user that the access is unauthorized under the currently-enforced security level. The example interface 800 further includes an exception request button 812 that permits the user to request an exception to the security level from an administrator.

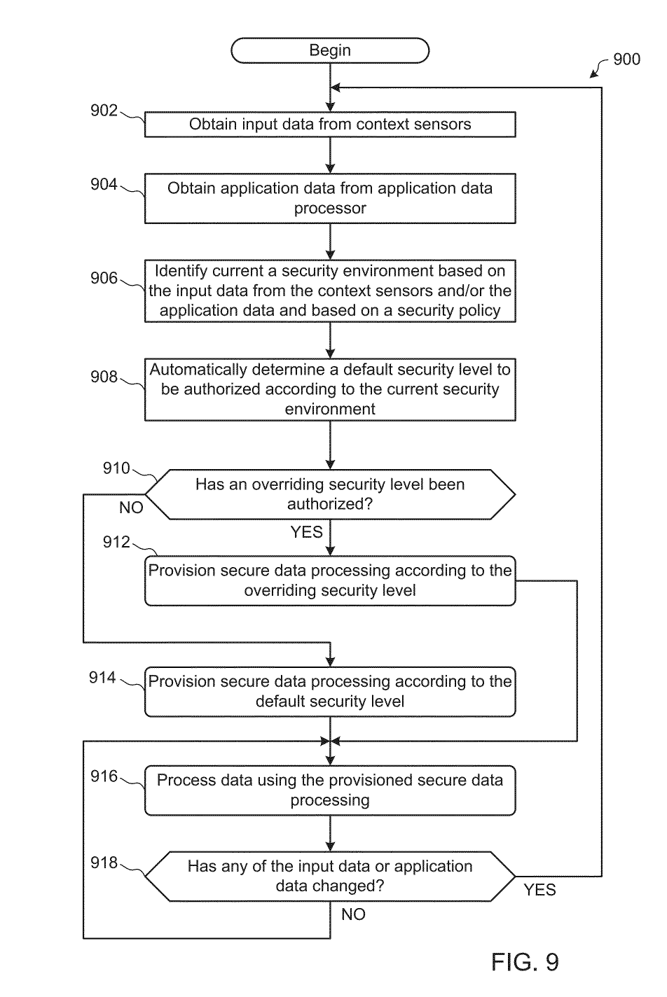

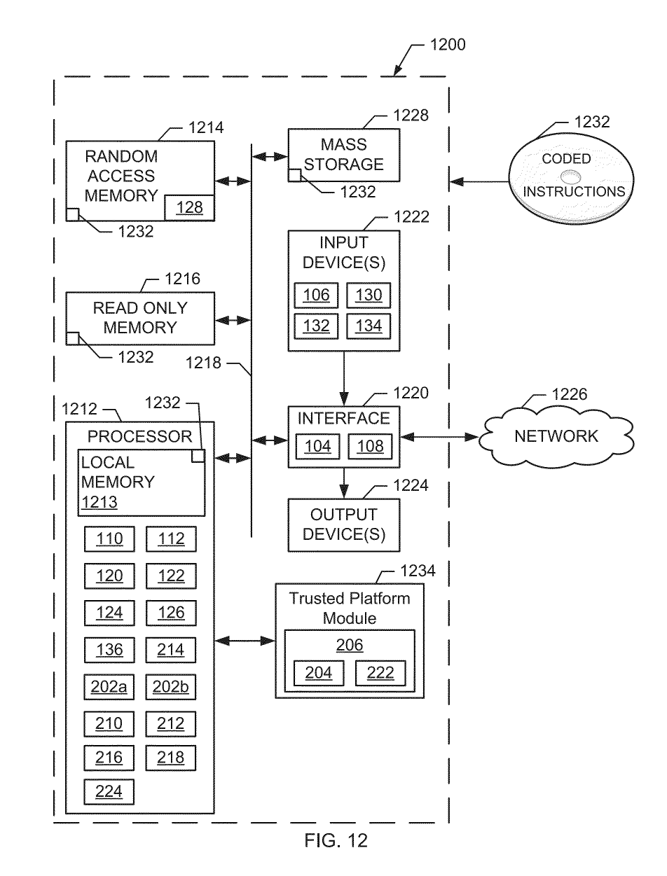

Flowcharts representative of example machine readable instructions for implementing the computing device 100 of FIGS. 1 and/or 2 are shown in FIGS. 9, 10, and 11. In this example, the machine readable instructions comprise programs for execution by a processor such as the processor 1212 shown in the example processor platform 1200 discussed below in connection with FIG. 12. The programs may be embodied in software stored on a tangible computer readable storage medium such as a CD-ROM, a floppy disk, a hard drive, a digital versatile disk (DVD), a Blu-ray disk, or a memory associated with the processor 1212, but the entire programs and/or parts thereof could alternatively be executed by a device other than the processor 1212 and/or embodied in firmware or dedicated hardware. Further, although the example programs are described with reference to the flowcharts illustrated in FIGS. 9, 10, and 11, many other methods of implementing the example computing device 100 may alternatively be used. For example, the order of execution of the blocks may be changed, and/or some of the blocks described may be changed, eliminated, or combined.

As mentioned above, the example processes of FIGS. 9, 10, and 11 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and transmission media. As used herein, “tangible computer readable storage medium” and “tangible machine readable storage medium” are used interchangeably. Additionally or alternatively, the example processes of FIGS. 9, 10, and 11 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and transmission media. As used herein, when the phrase “at least” is used as the transition term in a preamble of a claim, it is open-ended in the same manner as the term “comprising” is open ended.

FIG. 9 is a flowchart representative of example machine readable instructions 900 which may be executed to implement the example computing device 100 of FIG. 1 to automatically securely process data based on identifying a security environment.

The example environment identifier 112 of FIG. 1 obtains input data from context sensors (e.g., the sensors 102-110 of FIG. 1) (block 902). For example, the environment identifier 112 may receive one or more of: an access point name, a network identifier, or a domain name from the network interface 104; a geolocation measurement from the geolocation sensor 106; close proximity communication information, such as an NDEF file or the like, from the close proximity communications interface 108; and/or a time and/or date from the clock 110. The example environment identifier 112 also obtains application data from the application data processor 120 (block 904). For example, the application data may include calendar information from a calendar software application, virtual private network connection information from a data loss prevention application, or shared data information from a data access application.

The example environment identifier 112 identifies a current security environment in which the computing device 100 is located based on the input data (from the context sensors 102-110) and/or the application data, and based on the security policy 114 (block 906). For example, the environment identifier 112 may compare received context data and/or application data to the security environment definitions 116 defined in the security policy 114.

The example security level selector 126 automatically determines a default security level to be authorized according to the identified current security environment (block 908). For example, the security level selector 126 may look up the identified security environment in the environment to security level lookup table 128 of FIG. 1. Additionally or alternatively, the example key manager 206 of the security level selector 126 of FIG. 2 compares 1) a hash value that is generated by the environment identifier 112 and corresponds to the identified security environment to 2) a set of environment hashes 222 stored in the key manager 206.

The example security level selector 126 determines whether an overriding security level has been authorized (block 910). For example, the security level selector 126 may receive a request for a security level different than the default security level (e.g., determined in block 908) to be applied to a specific file or program. When such a request is input by the user, the example security level selector 126 determines whether the user is authorized to make such a change and/or whether an authorized party has approved the request. In some examples, the security level selector 126 accesses a lookup table of permissions assigned to a user of the computing device 100 to determine whether the requested override is permitted to be performed by the user. Additionally or alternatively, the example security level selector 126 may initiate a request to an administrative entity to request authorization for the override and/or access a list of authorizations already given by such an administrative entity.

When an overriding security level has been authorized (block 910), the secure data processor 136 provisions secure data processing according to the overriding security level (block 912). For example, the secure data processor 136 may use a higher or lower security level than the default security level to secure generated content and/or to access secured data.

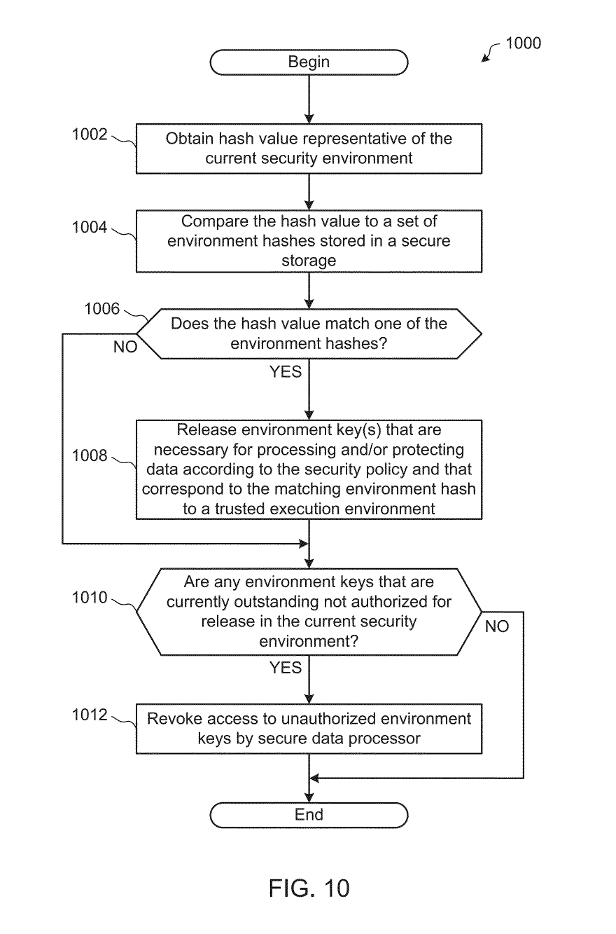

If an overriding security level has not been authorized (block 910), the secure data processor 136 provisions secure data processing according to the default security level (block 914). For example, the secure data processor 136 (e.g., via the key manager 206 of FIG. 2) may provision secure data processing, the example key manager 206 may selectively release environment keys 204 to a trusted execution environment (e.g., the trusted execution environment 202a, 202b of FIG. 2) to enable the trusted execution environment 202a, 202b to access and/or secure data at the corresponding security levels. The key manager 206 releases those ones of the environment keys that correspond to an identified environment and/or security level and/or to an overriding security level. Example instructions for implementing blocks 912 and/or 914 are described below with reference to FIG. 10.

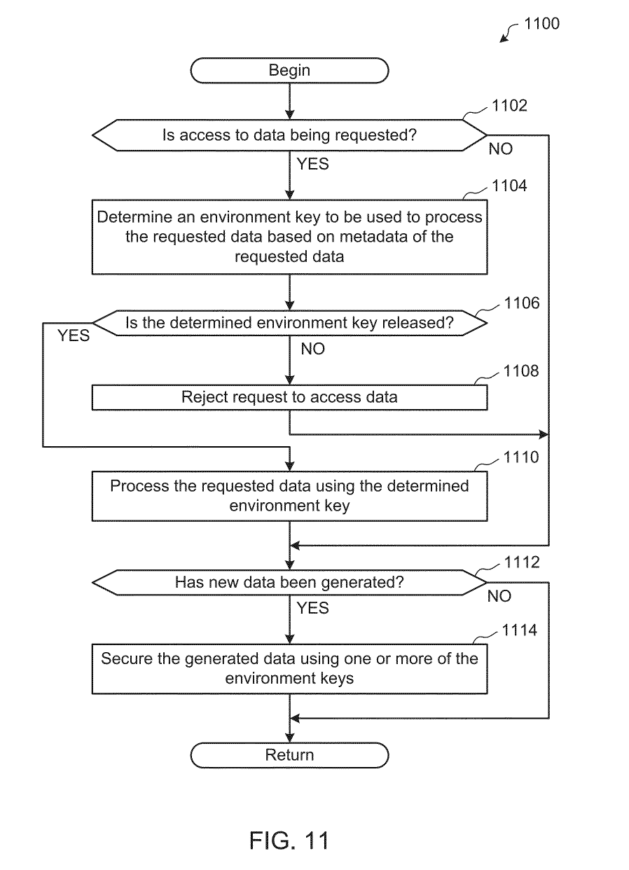

After provisioning secure data processing according to the default security level (block 914) or according to the overriding security level (block 912), the example secure data processor 136 processes data using the provisioned secure data processing (block 916). For example, the secure data processor 136 may use one or more environment keys that have been provisioned based on a default security level and/or an overriding security level to access data at the computing device 100 and/or to secure data generated at the computing device 100. An example process to implement block 916 is described below with reference to FIG. 11.

The example environment identifier 112 of FIG. 1 determines whether any of the input data or application data has changed (block 918). For example, the environment identifier 112 continually and/or repeatedly monitors data received from the sensors 102 and/or the application data processor 120 to identify whether the security environment has changed. If the input data and/or the application data has changed (block 918), control returns to block 902 to obtain input data from the context sensors 102. On the other hand, if the input data and the application data have not changed (block 918), control returns to block 916 to continue processing data using the provisioned secure data processing.

FIG. 10 is a flowchart representative of example machine readable instructions 1000 which may be executed to implement the example computing device 100 of FIG. 1 to provision secure data processing according to a security level. The example instructions 1000 of FIG. 10 may be executed to implement block 912 and/or to implement block 914 of FIG. 9 to provision secure data processing such as the secure data processing described above with reference to FIG. 2.

The example key manager 206 of FIG. 2 obtains a hash value (e.g., the hash value 220 of FIG. 2) representative of the current security environment (block 1002). For example, the environment identifier 112 of FIG. 2 may generate the hash value 220 based on a set of inputs to the environment identifier 112 and a corresponding determination of the security environment.

The example key manager 206 compares the hash value 220 to a set of environment hashes stored in a secure storage (block 1004). For example, the key manager 206 compares the hash value 220 to the set of environment hashes 222 securely stored in the key manager 206 to identify whether the hash value 220 matches any of the environment hashes. When the hash value 220 matches one of the environment hashes 222 (block 1006), the example key manager 206 releases environment key(s) 204 that are necessary for processing and/or protecting data according to a security policy (block 1008). For example, when the hash value 220 matches an environment hash 222 that corresponds to a medium security level, the example key manager 206 releases one or more environment keys 204 that correspond to the medium security level (and/or one or more lower security levels that are also authorized by virtue of the authorization of the medium security level). The example TEE manager 216 of FIG. 2 provisions the released keys to a trusted execution environment 202a, 202b that is requesting the environment keys 204 to access and/or protect data at the computing device 100.

After releasing the environment key(s) (block 1008), or if the hash value 220 does not match one of the environment hashes (block 1006), the example key manager 206 determines whether any of the environment keys 204 that are currently outstanding (e.g., released to a trusted execution environment 202a, 202b) not authorized for release in the current security environment (block 1010). For example, the key manager 206 may determine whether the release of any environment keys 204 must be revoked based on a change in the security environment (e.g., in response to a change in the hash value 220 output by the environment identifier 112). If any outstanding environment keys 204 are not authorized for release (block 1010), the example key manager 206 revokes access to the unauthorized environment keys by the secure data processor 136 (block 1012). For example, the key manager 206 may instruct the TEE manager 216 of FIG. 2 to revoke access to one or more environment keys 204 by the trusted execution environment 202a, 202b, which is required to comply.

After revoking access to unauthorized environment keys (block 1012), or if there are no unauthorized environment keys outstanding (block 1010), the example instructions 1000 end and control returns to a calling function, such as block 910 or block 912 of FIG. 9.

FIG. 11 is a flowchart representative of example machine readable instructions 1100 which may be executed to implement the example computing device 100 of FIG. 1 to process a resource according to a selected security level. The example instructions 1100 of FIG. 11 may be executed to implement block 916 of FIG. 9 to process data using a provisioned secure data processing.

The example secure data processor 136 determines whether access to data is being requested (block 1102). For example, the trusted execution environment 202a, 202b of FIG. 2 may determine whether the subordinate resource 214 is requesting access to the data (e.g., stored locally on the computing device 100 and/or access remotely via a network interface) via the trusted execution environment 202a, 202b. If access to data is being requested (block 1102), the example secure data processor 136 determines an environment key 204 to be used to process the requested data (block 1104). For example, the trusted execution environment 202a, 202b may select a single environment key 204 that has been provisioned to the trusted execution environment 202a, 202b and/or may determine which of multiple provisioned keys is to be used based on a security tag or other security-identifying metadata that corresponds to (e.g., is attached to) the data to be processed. In some other examples, the trusted execution environments 202a, 202b attempt to use the environment keys 204 that have been released to access the data (e.g., when the data does not indicate which of the environment keys 204 should be used).

The example secure data processor 136 determines whether the determined environment key 204 has been released (e.g., by a key manager 206, a trusted platform module, or another secure storage and environment key management system) (block 1106). For example, the secure data processor 136 of FIG. 1 may compare the required key to a set of environment keys 204 that have been released to the secure data processor 136. Additionally or alternatively, the example secure data processor may attempt to process all or a portion of the data using one or more released environment keys 204 to determine whether the appropriate key is present.

If the determined environment key 204 is not released (block 1106), the example secure data processor 136 rejects the request to access the data (block 1108). On the other hand, if the determined environment key 204 has been released (block 1106), the secure data processor 136 processed the requested data using the determined environment key 204 (e.g., to provide the requested access) (block 1110). For example, the secure data processor 136 decrypts secured data using the determined environment key 204 to enable modification, display, and/or any other use of the decrypted data.

After processing the requested data (block 1110) or rejecting the request (block 1108), or if access to data has not been requested (block 1102), the example secure data processor 136 determines whether new data has been generated at the computing device 100 (block 1112). For example, the secure data processor 136 determines whether any of the audio capture device 130, the image sensor 132, the user input device 134, or any other input device has generated new data (e.g., within the confines of a secure data processing environment that is inaccessible to other applications).

If new data has been generated (block 1112), the secure data processor 136 secures the generated data using one or more of the environment keys (block 1114). For example, the secure data processor 136 may encrypt the data using an environment key 204 that corresponds to a default security level determined by the security level selector 126. In the example of FIG. 2, the trusted execution environment 202a does not permit transfer of the data out of the trusted execution environment 202a unless and until the data is secured (e.g., encrypted, tagged with metadata corresponding to the security level, etc.) using the environment key(s) 204 released by the key manager 206.

After securing the generated data (block 1114), or if no new data has been generated (block 1112), the example instructions 1100 of FIG. 11 end and control is transferred to a calling function such as block 916 of FIG. 9.

FIG. 12 is a block diagram of an example processor platform 1200 capable of executing the instructions of FIGS. 9, 10, and 11 to implement the computing device 100 of FIG. 1. The processor platform 1200 can be, for example, a server, a personal computer, a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, or any other type of computing device.

The processor platform 1200 of the illustrated example includes a processor 1212. The processor 1212 of the illustrated example is hardware. For example, the processor 1212 can be implemented by one or more integrated circuits, logic circuits, microprocessors or controllers from any desired family or manufacturer. The example processor 1212 of FIG. 12 implements the example clock 110, the example environment identifier 112, the example application data processor 120, the example applications 122, 124, 210, 212, the example security level selector 126, the example secure data processor 136, the trusted execution environments 202a, 202b, the subordinate resource 214, the TEE manager 216, the context collector 218, and/or the policy manager 224 of FIGS. 1 and/or 2.

The processor 1212 of the illustrated example includes a local memory 1213 (e.g., a cache). The processor 1212 of the illustrated example is in communication with a main memory including a volatile memory 1214 and a non-volatile memory 1216 via a bus 1218. The volatile memory 1214 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1216 may be implemented by flash memory and/or any other desired type of memory device. Access to the main memory 1214, 1216 is controlled by a memory controller. The example memory 1214 of FIG. 12 implements the example environment to security level lookup table 128. The environment to security level lookup table 128 may additionally or alternatively be implemented via the local memory 1213, the non-volatile memory 1216 and/or the mass storage device 1228.

The processor platform 1200 of the illustrated example also includes an interface circuit 1220. The interface circuit 1220 may be implemented by any type of interface standard, such as an Ethernet interface, a universal serial bus (USB), and/or a PCI express interface. The example interface circuit 1220 of FIG. 12 implements the example network interface 104 and/or the example close proximity communications interface 108 of FIG. 1.

In the illustrated example, one or more input devices 1222 are connected to the interface circuit 1220. The input device(s) 1222 permit(s) a user to enter data and commands into the processor 1212. The input device(s) can be implemented by, for example, an audio sensor, a microphone, a camera (still or video), a keyboard, a button, a mouse, a touchscreen, a track-pad, a trackball, isopoint and/or a voice recognition system. The example input device(s) 1222 of FIG. 12 implements the example geolocation sensor 106, the example audio capture device 130, the example image sensor 132, and/or the example user input device 134 of FIG. 1.

One or more output devices 1224 are also connected to the interface circuit 1220 of the illustrated example. The output devices 1224 can be implemented, for example, by display devices (e.g., a light emitting diode (LED), an organic light emitting diode (OLED), a liquid crystal display, a cathode ray tube display (CRT), a touchscreen, a tactile output device, a light emitting diode (LED), a printer and/or speakers). The interface circuit 1220 of the illustrated example, thus, typically includes a graphics driver card, a graphics driver chip or a graphics driver processor.

The interface circuit 1220 of the illustrated example also includes a communication device such as a transmitter, a receiver, a transceiver, a modem and/or network interface card to facilitate exchange of data with external machines (e.g., computing devices of any kind) via a network 1226 (e.g., an Ethernet connection, a digital subscriber line (DSL), a telephone line, coaxial cable, a cellular telephone system, etc.).

The processor platform 1200 of the illustrated example also includes one or more mass storage devices 1228 for storing software and/or data. Examples of such mass storage devices 1228 include floppy disk drives, hard drive disks, compact disk drives, Blu-ray disk drives, RAID systems, and digital versatile disk (DVD) drives.

The coded instructions 1232 of FIGS. 9, 10, and/or 11 may be stored in the mass storage device 1228, in the volatile memory 1214, in the non-volatile memory 1216, and/or on a removable tangible computer readable storage medium such as a CD or DVD.

The example processor platform 1200 of FIG. 12 further includes a Trusted Platform Module 1234. The Trusted Platform Module 1234 of FIG. 12 provides secure data processing and/or storage capabilities for the processor 1212, and provides a source of data authentication. The example Trusted Platform Module 1234 implements the key manager 206, the environment keys 204, and/or the environment hashes 222 of FIG. 2.

As described above, disclosed methods and apparatus enhance compliance with a data security policy by automatically recognizing the appropriate security level to be applied to the environment in which a computing device is located. As a result, disclosed methods and apparatus reduce policy non-compliance caused by users of such computing devices by reducing or eliminating the opportunities for users to fail to comply with the applicable security policies and reducing or eliminating the reliance of the security policy on the user taking the appropriate action. Therefore, disclosed methods and apparatus provide benefits to the technical field of data security.

The following examples, which include subject matter such as a computing device to process data, a method to process data, and/or at least one computer-readable medium instruction that, when performed by a machine cause the machine to process data, are disclosed herein.

Example 1 is a computing device to process data, which includes an input device to capture information indicating a physical environment in which the computing device is located, an environment identifier to identify a security environment based on the captured information and a security policy, where the security policy defines the security environment and security levels, a security level selector to select, based on the security environment, one of the security levels to be authorized at the computing device within the security environment, and a secure data processor to process data based on the selected security level.

Example 2 includes the subject matter of example 1, wherein the environment identifier is to identify the security environment by determining whether the information matches a definition of the security environment in the security policy.

Example 3 includes the subject matter of examples 1 or 2, wherein the secure data processor includes a key manager to manage a set of keys corresponding to the security levels, and a secure execution environment to process the data using one of the keys that corresponds to the selected security level.

Example 4 includes the subject matter of example 3, wherein the secure execution environment encrypts the data using the one of the keys when the data is not previously protected at the selected security level.

Example 5 includes the subject matter of example 3, wherein the secure execution environment decrypts the data using the one of the keys when the data is protected at the selected security level, and is to permit use of the decrypted data within the secure execution environment.

Example 6 includes the subject matter of one or more of examples 1-5, wherein the input device includes at least one of a communications network interface, a close proximity communications interface, a location sensor, or a clock.

Example 7 includes the subject matter of one or more of examples 1-6, and further includes an application data processor to access application data corresponding to an application executing on the computing device, where the environment identifier determines the security environment based on the application data.

Example 8 is a method to process data that includes obtaining a set of inputs at a first device, determining a security environment based on the set of inputs and a security policy, where the security policy defines the security environment and security levels, determining, based on the security environment, one of the security levels to be authorized at the first device within the security environment, and processing data at the first device based on the one of the security levels.

Example 9 includes the subject matter of example 8, wherein the data includes at least one of a video captured via an image sensor, a still image captured by the image sensor, text data captured via a text input device, or audio captured by an audio sensor.

Example 10 includes the subject matter of example 9, wherein processing the data includes tagging the data with metadata indicating that access to the data is to be restricted based on the determined security level.

Example 11 includes the subject matter of example 9, wherein processing the data includes encrypting the data using an encryption key corresponding to the determined security level.

Example 12 includes the subject matter of one or more of examples 8-11, wherein the set of inputs includes at least one of a physical location, an identification of a communication network to which the first device is connected, an identification of a second device that is within a threshold physical distance of the first device.

Example 13 includes the subject matter of one or more of examples 8-12, wherein determining the security environment comprises identifying a physical boundary specified in the security policy.

Example 14 includes the subject matter of one or more of examples 8-13, and further includes identifying a selection of a second security level to override the determined security level, and processing second data at the first device based on the second security level.

Example 15 includes the subject matter of one or more of examples 8-14, and further includes determining a default classification level corresponding to the security environment, where determining the security level is based on the default classification level.

Example 16 includes the subject matter of one or more of examples 8-15, and further includes provisioning a secure processing environment with information necessary to process the data at the determined security level in response to determining the one of the security levels to be authorized.

Example 17 includes the subject matter of example 16, and further includes de-provisioning the secure processing environment in response to identifying a change in the security environment.

Example 18 includes the subject matter of one or more of examples 8-17, and further includes obtaining a set of second inputs at the first device, determining a second security environment based on the set of second inputs and the security policy, and determining, based on applying the security policy to the set of second inputs, a second one of the security levels to be authorized at the first device within the security environment.

Example 19 includes the subject matter of one or more of examples 8-18, wherein processing the data includes restricting access to the data when the data is protected at a more restrictive security level than the one of the security levels.

Example 20 is a tangible computer readable storage medium comprising computer readable instructions which, when executed, cause a processor of a first device to at least securely access a set of inputs collected via respective sensors, determine a security environment based on the set of inputs and a security policy, where the security policy defines the security environment and security levels, determine, based on the security environment, one of the security levels to be authorized within the security environment, and process data based on the determined security level.

Example 21 includes the subject matter of example 20, wherein the data includes at least one of a video captured via an image sensor of the first device, a still image captured by the image sensor of the first device, text data captured via a text input device of the first device, or audio captured by an audio sensor of the first device.

Example 22 includes the subject matter of example 21, wherein the instructions cause the processor to process the data by tagging the data with metadata indicating that access to the data is to be restricted based on the determined security level.

Example 23 includes the subject matter of example 21, wherein the instructions cause the processor to process the data by encrypting the data using an encryption key corresponding to the determined security level.

Example 24 includes the subject matter of one or more of examples 20-23, wherein the set of inputs includes at least one of a physical location, an identification of a communication network to which the first device is connected, an identification of a second device that is within a threshold physical distance of the first device.

Example 25 includes the subject matter of example 24, wherein the instructions cause the processor to access the set of inputs by executing an instruction within a trusted execution environment.

Example 26 includes the subject matter of one or more of examples 20-25, wherein the instructions cause the processor to determine the security environment by identifying a physical boundary specified in the security policy.

Example 27 includes the subject matter of one or more of examples 20-26, wherein the instructions further cause the processor to identify a selection of a second security level to override the determined security level, and process second data at the first device based on the second security level.

Example 28 includes the subject matter of one or more of examples 20-27, wherein the instructions further cause the processor to determine a default classification level corresponding to the security environment, and the instructions cause the processor to determine the one of the security levels based on the default classification level.

Example 29 includes the subject matter of one or more of examples 20-28, wherein the instructions further cause the processor to provision a secure processing environment with information necessary to process resources at the determined security level in response to determining the one of the security levels to be authorized.

Example 30 includes the subject matter of example 29, wherein the instructions further cause the processor to de-provision the secure processing environment in response to identifying a change in the security environment.

Example 31 includes the subject matter of one or more of examples 20-30, wherein the instructions further cause the processor to securely access a set of second inputs at the first device, determine a second security environment based on the set of second inputs and the security policy, and determine, based on applying the security policy to the set of second inputs, a second one of the security levels to be authorized within the security environment.

Example 32 includes the subject matter of one or more of examples 20-31, wherein the instructions cause the processor to process the data within a trusted execution environment based on a key that is released by a trusted platform module for use within the trusted execution environment.

Example 33 includes the subject matter of one or more of examples 20-32, wherein the instructions cause the processor to process the data by restricting access to the data when the data is protected at a more restrictive security level than the one of the security levels.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

1. A computing device to process data, comprising:
an input device to capture information indicating a physical environment in which the computing device is located;
an environment identifier to identify a security environment based on the captured information and a security policy, the security policy defining the security environment and security levels;
a security level selector to select, based on the security environment, one of the security levels to be authorized at the computing device within the security environment; and
a secure data processor to process data based on the selected security level.

2. A computing device as defined in claim 1, wherein the environment identifier is to identify the security environment by determining whether the information matches a definition of the security environment in the security policy.

3. A computing device as defined in claim 1, wherein the secure data processor comprises:
a key manager to manage a set of keys corresponding to the security levels; and
a secure execution environment to process the data using one of the keys that corresponds to the selected security level.

4. A computing device as defined in claim 3, wherein the secure execution environment is to encrypt the data using the one of the keys when the data is not previously protected at the selected security level.

5. A computing device as defined in claim 3, wherein the secure execution environment is to decrypt the data using the one of the keys when the data is protected at the selected security level, and is to permit use of the decrypted data within the secure execution environment.

6. A computing device as defined in claim 1, wherein the input device comprises at least one of a communications network interface, a close proximity communications interface, a location sensor, or a clock.

7. A computing device as defined in claim 1, further comprising an application data processor to access application data corresponding to an application executing on the computing device, the environment identifier to determine the security environment based on the application data.

8. A method to process data, comprising:
obtaining a set of inputs at a first device;
determining a security environment based on the set of inputs and a security policy, the security policy defining the security environment and security levels;
determining, based on the security environment, one of the security levels to be authorized at the first device within the security environment; and
processing data at the first device based on the one of the security levels.

9. A method as defined in claim 8, wherein the data comprises at least one of a video captured via an image sensor, a still image captured by the image sensor, text data captured via a text input device, or audio captured by an audio sensor.

10. A method as defined in claim 9, wherein processing the data comprises tagging the data with metadata indicating that access to the data is to be restricted based on the determined security level.

11. A method as defined in claim 9, wherein processing the data comprises encrypting the data using an encryption key corresponding to the determined security level.

12-19. (canceled)

20. A tangible computer readable storage medium comprising computer readable instructions which, when executed, cause a processor of a first device to at least:
securely access a set of inputs collected via respective sensors;
determine a security environment based on the set of inputs and a security policy, the security policy defining the security environment and security levels;
determine, based on the security environment, one of the security levels to be authorized within the security environment; and
process data based on the determined security level.

21. A storage medium as defined in claim 20, wherein the data comprises at least one of a video captured via an image sensor of the first device, a still image captured by the image sensor of the first device, text data captured via a text input device of the first device, or audio captured by an audio sensor of the first device.

22. A storage medium as defined in claim 21, wherein the instructions are to cause the processor to process the data by tagging the data with metadata indicating that access to the data is to be restricted based on the determined security level.

23. A storage medium as defined in claim 21, wherein the instructions are to cause the processor to process the data by encrypting the data using an encryption key corresponding to the determined security level.

24. A storage medium as defined in claim 20, wherein the set of inputs comprises at least one of a physical location, an identification of a communication network to which the first device is connected, an identification of a second device that is within a threshold physical distance of the first device.

25. A storage medium as defined in claim 24, wherein the instructions are to cause the processor to access the set of inputs by executing an instruction within a trusted execution environment.

26. A storage medium as defined in claim 20, wherein the instructions are to cause the processor to determine the security environment by identifying a physical boundary specified in the security policy.

27. A storage medium as defined in claim 20, wherein the instructions are further to cause the processor to identify a selection of a second security level to override the determined security level, and process second data at the first device based on the second security level.

28. A storage medium as defined in claim 20, wherein the instructions are further to cause the processor to determine a default classification level corresponding to the security environment, the instructions to cause the processor to determine the one of the security levels based on the default classification level.

29. A storage medium as defined in claim 20, wherein the instructions are further to cause the processor to provision a secure processing environment with information necessary to process resources at the determined security level in response to determining the one of the security levels to be authorized.

30. A storage medium as defined in claim 29, wherein the instructions are further to cause the processor to de-provision the secure processing environment in response to identifying a change in the security environment.

31. A storage medium as defined in claim 20, wherein the instructions are further to cause the processor to:
securely access a set of second inputs at the first device;
determine a second security environment based on the set of second inputs and the security policy; and
determine, based on applying the security policy to the set of second inputs, a second one of the security levels to be authorized within the security environment.

32. A storage medium as defined in claim 20, wherein the instructions are to cause the processor to process the data within a trusted execution environment based on a key that is released by a trusted platform module for use within the trusted execution environment.

33. A storage medium as defined in claim 20, wherein the instructions are to cause the processor to process the data by restricting access to the data when the data is protected at a more restrictive security level than the one of the security levels.
